(19) United States
(12) Patent Application Publication
(10) Pub. No.: US 2012/0048318 A1
(43) Pub. Date: Mar. 1, 2012

(54) KNEE SLING FOR USE WITH WALKER

(76) Inventors: Todd Zendzian, Avon, CT (US); Mary Beth Zendzian, Avon, CT (US)

(21) Appl. No.: 13/221,512

(22) Filed: Aug. 30, 2011

Related U.S. Application Data
(60) Provisional application No. 61/378,530, filed on Aug. 31, 2010.

(51) Int. Cl. A61H 3/00; B23P 11/00; A47C 7/52

(52) U.S. Cl. 135/66; 297/423.39; 29/428

(57) ABSTRACT

A leg support device suitable for use with a walker and a method for attaching the leg support device to the walker are disclosed. A leg support device includes a leg support configured to support a leg of a patient and has a first side and a second side opposite the first side. The leg support device further includes a first handle that is attached to the first side of the leg support, extends in a vertically upward direction, and has a first releasable connector. The leg support device further includes a second handle that is attached to the second side of the leg support, extends in a vertically upward direction, and has a second releasable connector. The leg support device further includes at least one crossbar strap that is attached to one of the first side and the second side of the leg support, extends in a vertically downward direction, and has a third releasable connector.

### CROSS-REFERENCE TO RELATED APPLICATIONS

This application claims priority under 35 U.S.C. §119(e) to U.S. Provisional Application Ser. No. 61/378,530 entitled “KNEE SLING FOR USE WITH WALKER,” filed on Aug. 31, 2010, which is incorporated herein by reference in its entirety.

### FIELD OF THE INVENTION

The present invention relates to medical devices. More specifically, the invention relates to a leg sling or leg support device suitable for use with a walker (preferably a rolling walker) which provides support for keeping a leg or foot off the floor as a patient ambulates, while transferring the load to the walker handles.

### BACKGROUND OF THE INVENTION

Leg support devices for use with walkers are known in the art. However, all of these devices require the use of hardware to install the support devices. While most of the leg supports are adjustable, all require the use of tools and hardware to make the adjustment. Such devices are disclosed in U.S. Pat. Nos. 3,596,668, 4,722,356, 5,086,798, 5,291,909, 5,605,169, and 6,123,089.

The present device is lightweight and flexible, and installable, adjustable and removable without the use of hardware or tools. When the walker is folded for storage, the device is foldable along with it, eliminating the need for removal prior to folding and storing the walker. The present device is fully adjustable for use with either the right or left leg. It can be adjusted higher or lower to accommodate the specific needs of the patient. The device is easy to maintain and clean.

### BRIEF SUMMARY OF THE INVENTION

Aspects and embodiments of the present disclosure are directed to a leg sling or leg support device for use in conjunction with a walker for supporting a leg of a patient off the ground when the patient walks. In one aspect, the leg support device has a leg support to support and move the patient's leg while using the walker. The leg sling may have at least two attaching handles extending essentially vertically from the leg support for attaching the sling to the walker handles for transferring load from the leg support to the walker handle. Each attaching handle may have at least one connector releasably connecting the attaching handle to the walker handle. The leg support device is fully attachable, adjustable and removable without the use of tools or hardware.

According to one embodiment of the present disclosure, there is provided a leg support device. The leg support device comprises a leg support configured to support a leg of a patient and has a first side and a second side opposite the first side. The leg support device further comprises a first handle that is attached to the first side of the leg support, extends in a vertically upward direction, and has a first releasable connector. The leg support device further comprises a second handle that is attached to the second side of the leg support, extends in a vertically upward direction, and has a second releasable connector. The leg support device further comprises at least one crossbar strap that is attached to one of the first side and the second side of the leg support, extends in a vertically downward direction, and has a third releasable connector.

In accordance with another embodiment, the leg support device further comprises at least one horizontal strap that is attached to the one of the first side and the second side of the leg support, extends in a horizontally outward direction, and has a fourth releasable connector.

In accordance with another embodiment, the leg support device further comprises at least one side panel that is attached to one of the first side and the second side of the leg support, and extends in a vertically upward direction. In accordance with yet another embodiment, the first handle of the leg support device is attached to the at least one side panel. In accordance with some aspects of the leg support device, the at least one side panel is triangular in shape. In accordance with another aspect, a portion of the at least one side panel is cut away or removed.

In accordance with another embodiment of the leg support device, the first and second handles are each made of a material suitable for supporting a load of at least 300 pounds.

In accordance with another embodiment of the leg support device, the leg support is made of a flexible material that can support a load of at least 300 pounds. In accordance with some aspects, the leg support includes foam material. In accordance with another aspect, the leg support is reinforced with a stiff material.

In accordance with another embodiment of the leg support device, the first, second, and third releasable connectors are each adjustable.

According to another embodiment of the present disclosure, there is provided a leg support system. The leg support system comprises a walker including four vertical legs, two handles extending from the respective front and back vertical legs, a front cross member extending from the respective front vertical legs, and two side cross members extending from the respective front and back vertical legs below the two handles. The leg support system further comprises a leg support device including a leg support configured to support a leg of a patient and having a first side and a second side opposite the first side, a first handle attached to the first side of the leg support and extending in a vertically upward direction and having a first releasable connector, a second handle attached to the second side of the leg support and extending in a vertically upward direction and having a second releasable connector, and at least one crossbar strap attached to one of the first side and the second side of the leg support and extending in a vertically downward direction and having a third releasable connector.

In accordance with another embodiment of the leg support system, the leg support further comprises at least one horizontal strap that is attached to the one of the first side and the second side of the leg support, extends in a horizontally outward direction, and has a fourth releasable connector.

According to another embodiment of the present disclosure, there is provided a method for attaching a leg support device to a walker. The method comprises positioning a leg support device in an interior of a walker with a first side of the leg support device configured to allow the leg support to engage with a leg of a patient. The method further comprises pulling a first and a second handle of the leg support device over a handle of the walker and engaging releasable connectors that are associated with each of the first and second handles of the leg support device. The method further comprises adjusting the releasable connectors associated with the first and second handles of the leg support device to adjust a height of the leg support. The method further comprises pulling a crossbar strap of the leg support device around a side cross member of the walker and engaging another releasable connector associated with the crossbar strap.

In accordance with another embodiment, the method for attaching a leg support device to a walker further comprises pulling a horizontal strap around a front and a back vertical leg of the walker and engaging another releasable connector associated with the crossbar strap.

These and other aspects and embodiments are discussed in detail below. The foregoing information and the following detailed description include illustrative examples of various aspects and embodiments, and provide an overview or framework for understanding the nature and character of the claimed aspects and embodiments. The drawings provide illustration and a further understanding of the various aspects and embodiments, and are incorporated in and constitute a part of this specification. The drawings, together with the remainder of the specification, serve to describe and explain the claimed aspects and embodiments.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a side perspective view of a leg sling installed on a walker.

FIG. 2 is a top plan view of the leg sling, uninstalled.

FIG. 3 is a perspective view of the leg sling, uninstalled.

### DETAILED DESCRIPTION OF THE INVENTION

The devices, systems and methods described herein are not limited in their application to the details of construction and arrangement of components set forth in the description or illustrated in the drawings. The devices, systems and methods described herein are capable of other embodiments and of being practiced or of being carried out in various ways. Also, the phraseology and terminology used herein is for the purpose of description and should not be regarded as limiting.

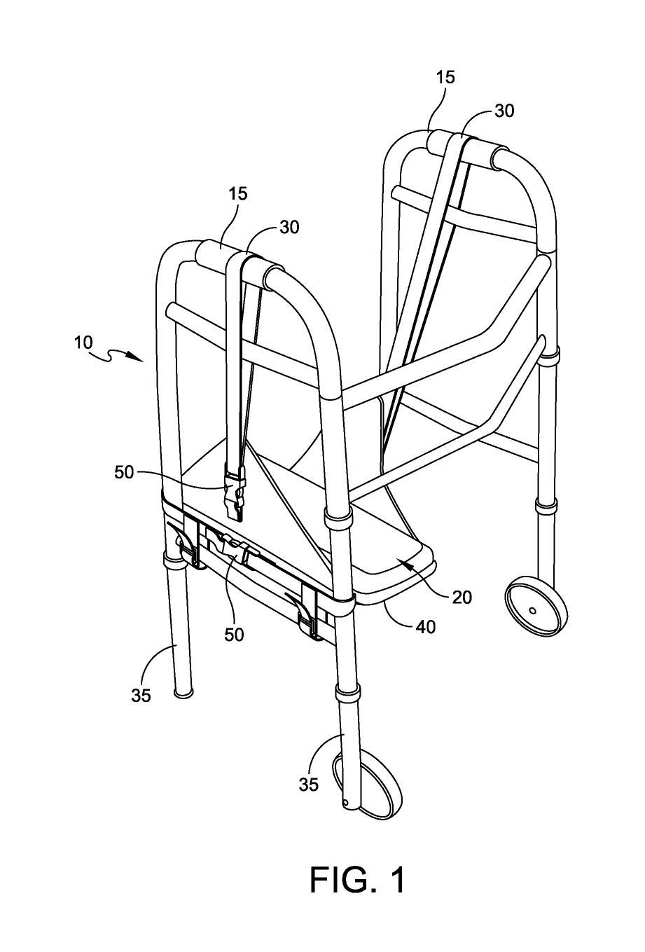

As seen in FIG. 1, a preferred embodiment of the leg sling 20 is for use in conjunction with a standard rolling walking frame 10. This embodiment of the leg sling 20 has at least two attaching handles 30 that are connectable to the leg support 40 and extend upwardly for attachment to the walker handles 15. The handles 30 have at least one releasable connector 50 which is used to attach the leg sling 20 to the walker handles 15 for use. The leg support handles 30 are preferably made of flexible or malleable material that can support a load of at least 300 pounds. In one embodiment, the leg support handles 30 are made of a one inch wide heavyweight webbing (such as is commonly used for rock climbing) that can support up to 1000 pounds and is water resistant and easily washable. The handles 30 effectively transfer the load carried on the leg support 40 to the walker handles 15 when the sling 20 is in use.

The leg support 40 is preferably made of a flexible material that can support a load of at least 300 pounds. The material is preferably a water resistant material. In one preferred embodiment, durable nylon sport fabric is employed. The leg support 40 is optionally cushioned with a layer of foam or the like to provide added comfort. One preferred foam is two inch high density, closed cell foam, which is typically found in yoga mats and like exercise mats and is easily washable. Additional support can be provided in the leg support 40 by positioning a stiff material on the inside of the leg support. One example is a ply wood. One preferred embodiment of ply wood can be about 0.5 inches thick. The leg support 40 is of sufficient size (width) that the patient's leg can fit comfortably within it and will not rub or bind when the sling 20 is in use. The leg support should not be excessively long so as to extend beyond the boundaries of the walker frame and become difficult for the patient to manipulate. The preferred range of size of the walker is from about 20 inches long by 10 inches wide to about 15 inches long by 5 inches wide.

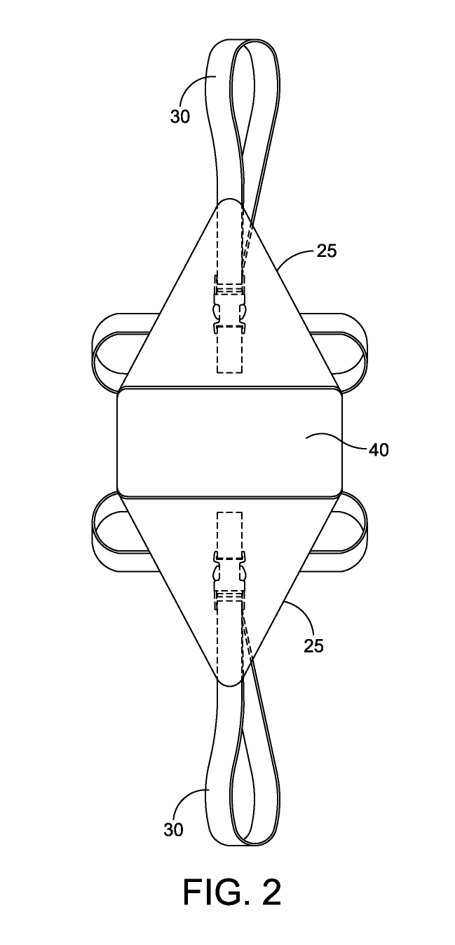

As seen in FIG. 2, the embodiment of leg sling 20 is equipped with side panels 25 which extend from each side of the support 40 and which facilitate attachment of the handles 30 to the support 40. The handles can be made from one inch heavy duty webbing, which is safe up to 1,000 pounds. The length of the handle can vary, and is commonly about 6 to 8 feet long. Optionally, the panels are triangularly shaped, and can be made from the same material as the leg support 40. The preferred dimensions of the triangular side panels are about 10 to 15 inches high by about 15 to 20 inches wide. In one preferred embodiment, a portion of one or both of the side panels 25 can be cut away or removed to help avoid contact between a patient's good leg and the sling 20 during the walking motion. For example, a panel 25 can have an opening that has an hourglass shape.

The releasable connectors 50 can be the same or different connectors. In one preferred embodiment, the connectors are buckles, such as squeeze buckles or cam buckles; however, any type of releasable connector that can support substantial weight can be employed. The most suitable connectors are adjustable, so that the height and position of the leg support 40 can be changed via increasing or decreasing the length of the handles 30. If the handles 30 are adjusted so that one handle is shorter than the other, the leg support 40 is shifted off-center, to the right or to the left, as desired. This allows the leg support 40 to be adjusted to support either leg of a patient. Additionally, if the handles 30 are both shortened, the leg support 40 will be raised to comfortably support the leg of a patient who has longer legs.

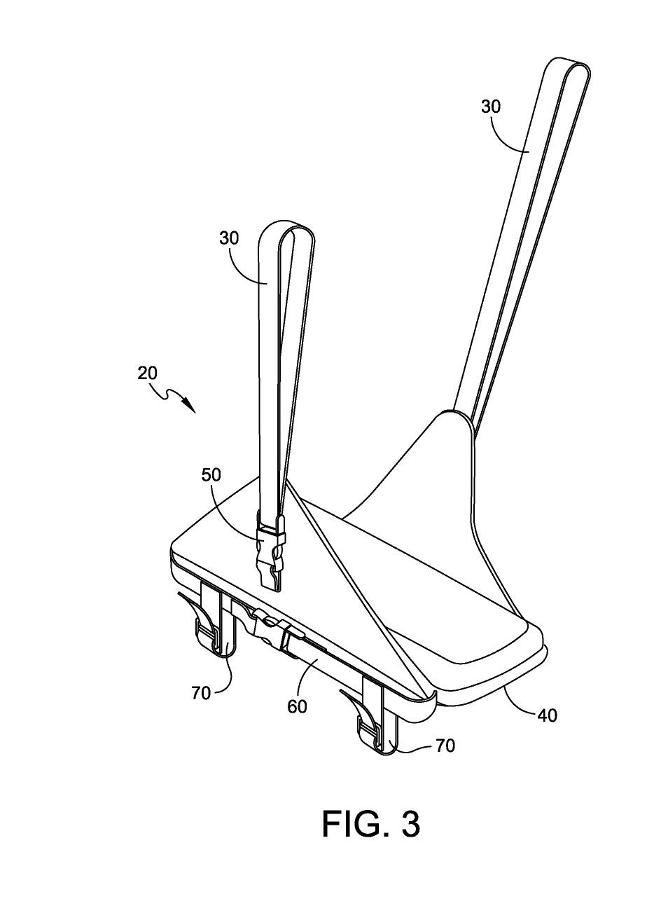

As seen in FIG. 3, the leg sling 20 optionally has additional straps 60 that can be used to secure the sling 20 around the walker legs 35. The horizontal straps 60 further secure the position of leg support 40, and prevent it from being accidentally flipped up or out of position when the knee of the patient is raised to place in the leg support 40. The horizontal strap is commonly about 2 to 4 feet long. Additionally, optional crossbar straps 70 can be employed to further secure the leg support 40 in place. Both the horizontal straps 60 and the crossbar straps 70 preferably have releasable connectors to enable adjustment. The crossbar straps 70 can be from about 1 to 3 feet long.

When the sling 20 is engaged with a rolling walker frame 10, as depicted in FIG. 1, a patient can insert his leg—bended at the knee—between the opposing side panels 25. While the patient uses the walker, the sling support 40 holds the patient's leg in a generally constant vertical position, thereby preventing the patient from bearing weight on his lower leg, ankle, or foot.

The disclosed device promotes:
Increased functional mobility—making standing and walking activities easier
Increased stability and balance
Improved cardiovascular capability
Safety—assures and maintains non weight bearing at the lower leg and foot
Improved energy expenditure
Increased independence
Overall improved well-being.

The disclosed device reduces:
Muscle imbalances during walking
Muscle atrophy at the affected limb and the rest of the body
Stress on joints and limbs
Fatigue in the upper and lower extremities

While a preferred embodiment has been set forth for purpose of illustration, the foregoing description should not be deemed a limitation of the devices, systems and methods described herein. Accordingly, various modifications, adaptations and alternatives may occur to one skilled in the art without departing from the spirit of the disclosure and scope of the claimed coverage.

What is claimed is:

1. A leg support device comprising:
a leg support configured to support a leg of a patient, the leg support having a first side and a second side opposite the first side;
a first handle attached to the first side of the leg support and extending in a vertically upward direction, the first handle having a first releasable connector;
a second handle attached to the second side of the leg support and extending in a vertically upward direction, the second handle having a second releasable connector; and
at least one crossbar strap attached to one of the first side and the second side of the leg support and extending in a vertically downward direction, the at least one crossbar strap having a third releasable connector.

2. The leg support device of claim 1, further comprising at least one horizontal strap attached to the one of the first side and the second side of the leg support and extending in a horizontally outward direction, the at least one horizontal strap having a fourth releasable connector.

3. The leg support device of claim 1, further comprising at least one side panel attached to the one of the first side and the second side of the leg support and extending in a vertically upward direction.

4. The leg support device of claim 3, wherein the first handle is attached to the at least one side panel.

5. The leg support device of claim 3, wherein the at least one side panel is triangular in shape.

6. The leg support device of claim 3, wherein a portion of the at least one side panel is cut away or removed.

7. The leg support device of claim 1, wherein the first and second handles are each made of a material suitable for supporting a load of at least 300 pounds.

8. The leg support device of claim 1, wherein the leg support is made of a flexible material that can support a load of at least 300 pounds.

9. The leg support device of claim 1, wherein the leg support includes foam material.

10. The leg support device of claim 9, wherein the leg support is reinforced with a stiff material.

11. The leg support device of claim 1, wherein the first, second, and third releasable connectors are each adjustable.

12. A leg support system, comprising:
a walker including
four vertical legs,
two handles extending from respective front and back vertical legs,
a front cross member extending from the respective front vertical legs, and
two side cross members extending from respective front and back vertical legs below the two handles; and
a leg support device including
a leg support configured to support a leg of a patient, the leg support having a first side and a second side opposite the first side,
a first handle attached to the first side of the leg support and extending in a vertically upward direction, the first handle having a first releasable connector,
a second handle attached to the second side of the leg support and extending in a vertically upward direction, the second handle having a second releasable connector, and
at least one crossbar strap attached to one of the first side and the second side of the leg support and extending in a vertically downward direction, the at least one crossbar strap having a third releasable connector.

13. The leg support system of claim 12, further comprising at least one horizontal strap attached to the one of the first side and the second side of the leg support and extending in a horizontally outward direction, the at least one horizontal strap having a fourth releasable connector.

14. The leg support system of claim 12, further comprising at least one side panel attached to the one of the first side and the second side of the leg support and extending in a vertically upward direction.

15. The leg support system of claim 14, wherein the first handle is attached to the at least one side panel.

16. The leg support system of claim 12, wherein the first and second handles are each made of a material suitable for supporting a load of at least 300 pounds.

17. The leg support system of claim 12, wherein the leg support is made of a flexible material that can support a load of at least 300 pounds.

18. The leg support system of claim 12, wherein the leg support includes foam material.

19. A method for attaching a leg support device to a walker, the method comprising:
positioning a leg support device in an interior of a walker with a first side of the leg support device configured to allow the leg support to engage with a leg of a patient;
pulling a first and a second handle of the leg support device over a handle of the walker;
engaging releasable connectors associated with the first and second handles of the leg support device;
adjusting the releasable connectors associated with the first and second handles of the leg support device to adjust a height of the leg support; and
pulling a crossbar strap of the leg support device around a side cross member of the walker; and
engaging another releasable connector associated with the crossbar strap.

20. The method of claim 19, further comprising pulling a horizontal strap around a front and a back vertical leg of the walker and engaging another releasable connector associated with the crossbar strap.
